(19) United States
(12) Patent Application Publication
(10) Pub. No.: US 2015/0093710 A1
(43) Pub. Date: Apr. 2, 2015

(54) APPARATUS FOR HEATING PLASTIC BITS

(71) Applicant: KRONES AG, Neutraubling (DE)

(72) Inventor: Thomas Friedlaender, Regensburg (DE)

(21) Appl. No.: 14/481,492

(22) Filed: Sep. 9, 2014

(30) Foreign Application Priority Data
Sep. 30, 2013 (DE) 102013219684.9

(51) Int. Cl. F27D 3/00

(52) U.S. Cl. CPC F27D 3/0033; F27D 2003/0034
USPC 432/28; 432/239

(57) ABSTRACT

An apparatus and a corresponding method for heating plastic bits, including a heating zone in which introduced plastic bits can be heated, and a heating device which is suited to conduct heat into the heating zone, the apparatus further including filling bodies which can be introduced into the heating zone and are suited to give off absorbed heat to the plastic bits in the heating zone.

### CROSS-REFERENCE TO RELATED APPLICATION

The present application claims priority to German Application No. 102013219684.9, filed Sep. 30, 2013. The priority application, DE 102013219684.9, is hereby incorporated by reference.

### FIELD OF THE DISCLOSURE

The present invention relates to an apparatus for heating plastic bits, such as, for example, recycled PET flakes.

### BACKGROUND

Apparatus for heating plastic bits obtained, for example, from recycled plastic bottles are known. Usually, systems of heating screws are used, into which the plastic bits are introduced and on the surface area of which the plastic bits can heat up. Critical factors for the uniform heating of the plastic bits are, in this case, the surface area of the heating apparatus, e.g. of the heating screw, the extent of the mixing of the plastic bits, as well as the energy input method, for example, whether the heat is transferred by means of microwaves or infrared radiation or whether the heat is directly exchanged by means of physical contact with the heating apparatus.

### OBJECT

Based on the prior art it is the object of the present invention to provide an improved apparatus for heating plastic bits.

### Summary of the Disclosure

The apparatus for heating plastic bits according to the present disclosure comprises a heating zone in which introduced plastic bits can be heated, and a heating device which is suited to conduct heat into the heating zone, wherein the apparatus further comprises filling bodies which can be introduced into the heating zone and are suited to give off absorbed heat to the plastic bits in the heating zone. This apparatus yields a clearly better result with respect to the heating process of the plastic bits and the heating uniformity of the plastic bits because the introduced filling bodies to be introduced give off heat to the plastic bits in addition to the surface area of the heating zone or possibly provided radiation sources, whilst being located in the middle of the plastic bits mixture.

It may be provided that the filling bodies can be passed through the heating zone with the plastic bits or are located in the heating zone. If the filling bodies are formed to be passed through the heating zone with the plastic bits it is possible to realize a heat exchange with the plastic bits for a longest possible duration. In the other case the possibly required screening device separating the plastic bits from the filling bodies may be waived, which makes the overall assembly technically easier to implement.

In one embodiment it is provided that the apparatus is characterized in that the heating zone comprises a heating screw. Heating screws are able to achieve a good heat distribution due to the permanent mixing of the plastic bits, so that it is always a different surface area of the plastic bits mixture that faces the heated surface of the heating screw, with the consequence that the plastic bits can be heated uniformly. Moreover, a transport of the plastic bits through the heating zone can thus be realized in a reliable manner.

In one embodiment it is provided that the heating device comprises at least one of a microwave radiation source, an infrared radiation source, an induction heater, a heatable inner surface area of the heating zone, which are suited to heat the filling bodies. The different properties of the heating sources, in particular the reaction of the plastic bits to being irradiated with the corresponding energy, allow the realization of specific heating targets. It is possible, for example, to use radiation for the heating of the filling bodies which is not absorbed by the plastic bits, which ensures that the plastic bits do not absorb too much heat, while the distribution of the filling bodies in the plastic bits still allows a targeted heating by the heat given off by the filling bodies.

In another embodiment the density of the filling material bodies corresponds to the medium density of the plastic bits. Thus, it can be prevented that the filling bodies are either only distributed on the surface area of the plastic bits or slide too far into the plastic bits.

According to a further development of the invention the filling bodies are fixedly connected to the surface area of the heating zone. This allows an effective heat transfer to the filling bodies and thereby an increased surface area of the heating zone, which improves the heating result of the plastic bits.

The apparatus may furthermore comprise a mixing device which is arranged in the heating zone and is suited to mix the plastic bits in the heating zone. This mixing device ensures that the filling bodies are statistically distributed in the total plastic bits flow as uniformly as possible, which considerably improves the result of the heating of plastic bits.

In addition, the outer shape of the filling bodies may be free of edges and/or free of corners. Thus, it can be prevented that small plastic particles, which could be abraded from the plastic bits by the friction of the filling bodies on the plastic bits, remain behind since a shape of the filling bodies free of edges and/or corners results in less abrasion.

In one embodiment the apparatus is characterized in that the ratio A/V of surface area to volume of the filling bodies is greater than that of a ball having the same volume. Thus, the heat emission of the filling bodies can be optimized.

According to a further development of the apparatus a supply device is provided, which is suited to supply the filling bodies to the plastic bits, and/or a separating device is provided, which is suited to separate the filling bodies from the plastic bits. The supply device allows the supply of the filling bodies to the flow of plastic bits at the appropriate time, and the separating device allows the performance of the further recycling process, thereby ensuring that no, or only an extremely small amount of filling bodies are contained in the plastic flow.

The use, for example, of one of these devices allows the realization of a method for heating plastic bits, wherein the plastic bits are filled into a heating zone and a heating device conducts heat into the heating zone, and wherein filling bodies are introduced into the heating zone, which give off absorbed heat to the plastic bits in the heating zone. This method allows a faster and more uniform heating of plastic bits.

In one embodiment of the method the filling bodies are passed through the heating zone with the plastic bits or are located in the heating zone. Passing the filling bodies through the heating zone with the plastic bits allows the heat transfer to take place for a longest possible duration. Locating the filling bodies in the heating zone ensures that the plastic flow flowing out of this heating zone or out of the entire apparatus contains no, or only a small number of filling bodies, so that the recycling process is not strongly influenced.

The method may furthermore comprise that the plastic bits are mixed by a mixing device in the heating zone. The mixing device can ensure a statistical uniform distribution of the filling bodies in the plastic bits flow.

It may be provided that heat is introduced into the interior of the heating zone by means of a microwave radiation source and/or an infrared radiation source and/or an induction heater and/or a heatable inner surface area of the heating zone. The use of specific energy sources for the heat supply in the heating zone can ensure that the plastic bits are heated in a specific manner.

According to an embodiment of the method the filling bodies have an absorption maximum in the microwave range and/or infrared range. These filling bodies absorb as much energy as possible from the corresponding radiation sources and are capable of uniformly giving this energy off to the plastic bits in the form of heat.

### BRIEF DESCRIPTION OF THE FIGURES

FIG. 1 shows a schematic view of an apparatus for heating plastic bits,

FIG. 2a shows a semi-schematic view of heating screw for heating plastic bits,

FIG. 2b shows an apparatus in the form of a rotating drum for heating plastic bits,

FIG. 2c is a cross-sectional view of filing body or paddle curves or on the outer surface of the heating screw of FIG. 2a to improve mixing of the flow of plastic bits,

FIG. 2d is a cross-sectional view of an alternate filing body or paddle on the outside surface of the heating screw of FIG. 2a, in which the filing body or paddle has undulations, thereby increasing the effective surface area of the filing body or paddle,

FIG. 3a shows a filling body in the shape of a ball,

FIG. 3b shows a filing body in the shape of a cylindrical plate,

FIG. 3c shows a filling body in the shape of a cuboid,

FIG. 3d shows a filling body in the shape of an ellipsoid,

FIG. 3e shows a filling body in the shape of a substantially three-dimensionally formed cross with six arms, the arms being rounded,

FIG. 3f shows a uniform distribution of plastic bits and filing bodies in a heating zone,

FIG. 3g shows a non-uniform distribution of plastic bits and higher-density filing bodies in a heating zone, with filing bodies sinking downwardly due to their higher density, and

FIG. 3h shows a non-uniform distribution of plastic bits and filing bodies, with the filing bodies accumulated on the plastic bits due to their relative size or a lower density of the filing bodies.

### DETAILED DESCRIPTION

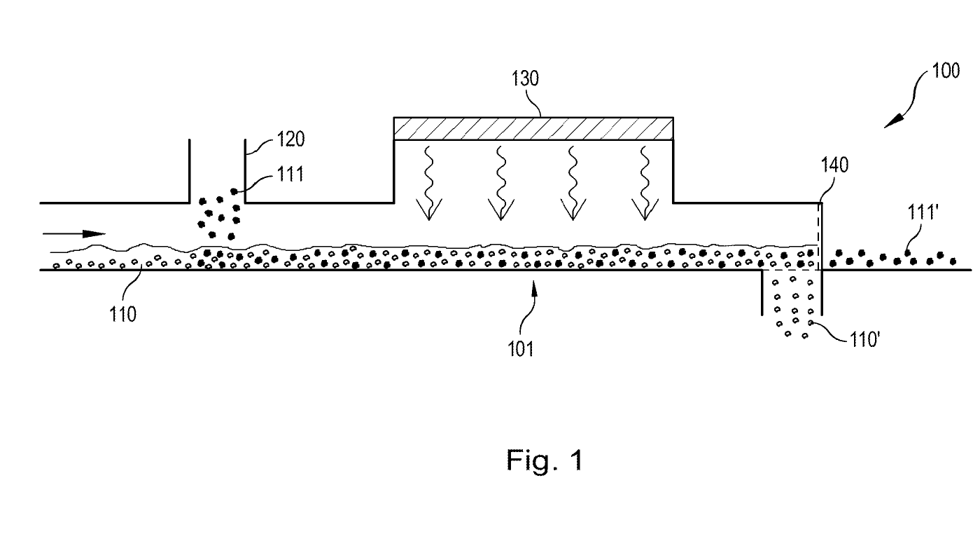

FIG. 1 schematically shows an apparatus 100 as used for the heating of plastic bits, e.g. from a plastic bits flow 110. The plastic bits may be both plastic flakes and plastic pellets. Basically, the apparatus is also capable of processing other, smaller plastic particles. The apparatus comprises a heating zone 101 into which the flow of plastic bits 110 is conducted. This can be accomplished, for example, by a conveyor. A heating device 130 is provided in the heating zone 101, which can heat the plastic bits. This heating device may be realized by most diverse energy sources. The heating device 130 can be, for example, a microwave radiation source or an infrared radiation source or an induction heater, or the inner walls of the heating zone 101 may be heated, e.g. by hot water or the like. This heat can then be transferred to the plastic bits 110. The heating zone 101 itself may be configured as a reactor in which the heating takes place, or for example as a heating screw.

Filling bodies 111 may be added to the flow of plastic bits 110 by a supply device 120. This supply device may be an ordinary supply line from which a flow of filling bodies 111 is added to the plastic bits flow 110. Based on the movement of the plastic bits flow 110 a distribution of the filling bodies 111 in the plastic bits flow takes place. It is provided that the filling bodies 111 absorb heat in the heating zone 101 from the heat emitted by the heating device and give this heat off to the plastic bits 110 in the plastic bits flow. The filling bodies 111 thus ensure, on the basis of their overall surface area, an increased heat emission to the plastic bits, in comparison with an apparatus for heating plastic bits that does not involve these filling bodies. Thus, it can be achieved that the plastic bits can be heated more uniformly and completely.

Preferably, the plastic bits 110′ that were heated in the heating zone 101 by the heating device 130 and the filling bodies 111′ are separated from the filling bodies 111′ at the end of the apparatus. To this end, for example, a separator 140 in the form of differently sized screens may be provided. It can be provided, for example, that the filling bodies 111 are larger than the plastic bits 110. In such a case, the separator may be provided in form of a screen in the bottom, as shown in FIG. 1, through which the plastic bits 110 are separated from the filling bodies 111. The filling bodies may then be reused or disposed of. As the plastic bits 110′ are usually heated within the scope of recycling processes (in this case usually in form of flakes from shredded plastic bottles) so as to allow the processing thereof to new bottles, it is provided that the separator provides for a high quality to the effect that the separation of plastic bits and filling bodies is realized as thoroughly as possible so that the properties of the filling bodies cannot negatively influence the further recycling process of the plastic bits 110′. Other separators are conceivable as well. For example, it may be provided that the plastic bits 111 react to magnetic or electric fields so that they may be filtered out from the plastic bits flow 110′ by means of powerful electromagnets at the end of the apparatus 100, thereby preventing the contamination of the plastic bits 110′. To this end, it may then be provided in one embodiment that the filling bodies contain a metal fraction which responds to the electromagnetic fields. However, it is also possible to use other, electromagnetically interacting materials.

The filling bodies 111 shown in FIG. 1 were introduced into the flow of plastic bits and passed with same through the apparatus for heating the plastic bits, meaning that they have passed the heating zone 101 with the heating device 130 exactly like the plastic bits.

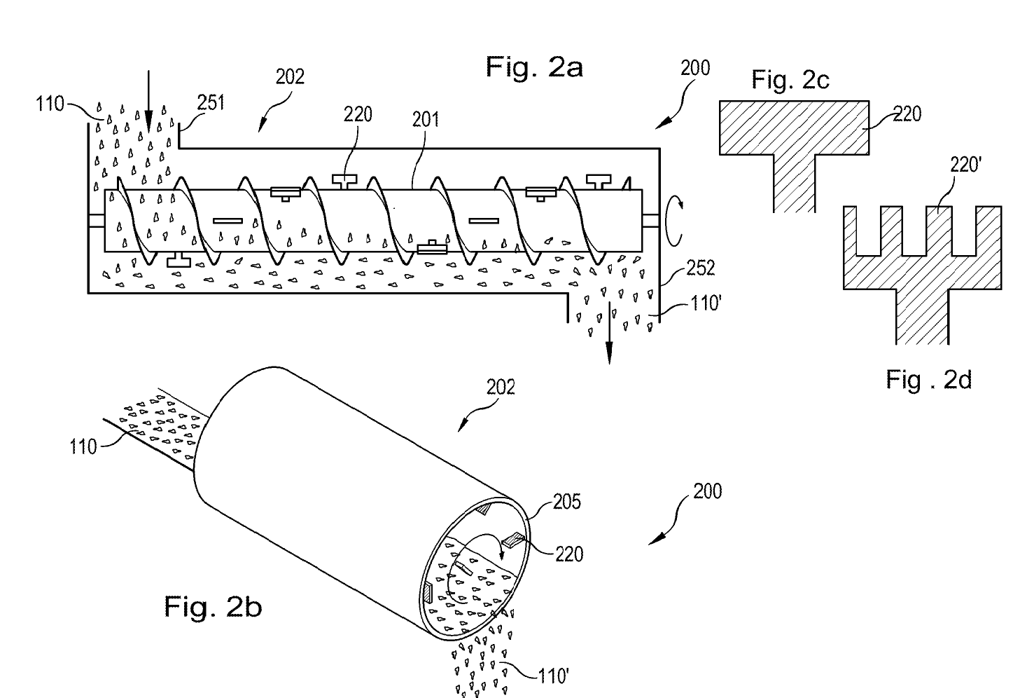

FIG. 2a shows another embodiment in which the filling bodies are fixedly connected to the heating device. The apparatus 200 comprises, in the embodiment according to FIG. 2a, a heating screw 201. This heating screw 201 may be mounted horizontally, or with a small downward inclination in the transport direction. If it is used as a conveyor screw, the heating screw may also be mounted with an upward inclination in the transport direction. The heating screw 201 and the surrounding housing together define the heating zone 202 into which the plastic bits 110 can be introduced, for example, through supply line 251. The rotational movement of the heating screw 201 then ensures that the plastic bits are transported through the heating zone 202, and are partially heated during this transport by the physical contact, for example, with the heating screw. The heated plastic bits 110′ can flow out of the heating zone through the outlet 252.

In this embodiment, the filling bodies are fixedly connected to the heating screw 201 and have the form of blades or paddles 220 (see FIG. 2c). The rotational movement of the heating screw 201 ensures that these filling bodies 220 are repeatedly introduced into the flow of plastic bits 110. Thus, a physical contact is established between the plastic bits 110 and the filling bodies 220. As the filling bodies 220 are physically connected to the heating screw 201 (this connection may either be permanent or separable to allow an exchange of the filling bodies) the filling bodies 220, too, have an increased temperature and are capable of heating the plastic bits 110 by a heat exchange. Providing the filling bodies 220 on the outer surface of the heating screw 201 increases the effective surface area of the heating screw 201, which may be used for heating the plastic bits. Moreover, the filling bodies 220 can penetrate, respectively, immerse into the flow of plastic bits 110, thus not only achieving a heating of the surface area of the plastic bits that faces the heating screw, but also a heating of the plastic bits that are positioned in deeper layers of the flow. This ensures a complete heating. Providing the filling bodies in the form of blades or paddles 220 furthermore allows a clearly improved mixing of the flow of plastic bits, with the consequence that the surface area of the plastic bits facing the heating devices (the heating screw and the filling bodies connected thereto) is subjected to permanent mixing, so that further the uniform heating of the plastic bits is improved. At the same time, carbonization or sticking to the heating device can be avoided.

It may also be provided that the filling bodies in this embodiment are not designed as massive components, e.g. in the form of a continuous metal plate, but it may also be provided that the individual blades 220 are fork-shaped, i.e. they do not have the shape of a rectangular plate, but have a prong shape 220. Thus, the mixing of the plastic bits can be carried out even more effectively, which may further improve the end result of the heating. It may also be provided that the filling bodies 220′, see FIG. 2d, are curved or undulated, allowing an increase of the effective surface area of the filling bodies 200, respectively 220′, and resulting in a better heat exchange.

FIG. 2b shows another embodiment in which the filling bodies 220 are fixedly connected to the heating zone 202. In this embodiment, the heating zone 202 is realized by a rotating drum 205 which may be disposed, similar to the heating screw, with a slight inclination or bevel in the transport direction so as to ensure an effective flow of the plastic bits 110 or effective transport of the plastic bits. In this embodiment, the filling bodies 220 are not arranged on the outside of the drum 205, as was the case with the heating screw according to FIG. 2a, but on the inside surface of the drum 205. Thus, it is achieved that the filling bodies penetrate into the plastic bits flow 110 at any rate, and mix said flow through entirely, as they come into contact not only with the surface area that is in contact with the drum. Depending on the shape of the filling bodies 220 it may also be intended to entrain plastic bits, which are then dropped, at the top, onto the flow of plastic bits 110 by the rotation of the filling bodies 220. Thus, an even better result of the mixing of the plastic bits is obtained, which is altogether beneficial for the uniform heating. In this embodiment, too, the filling bodies 220 can be realized in a different manner. They can be designed, for example, in the form of flat metal plates, similar to FIG. 2a, or in the form of forks. They may also include an inner curvature, thereby increasing the overall surface area available for the heating of plastic bits.

The embodiments of the heating zone in form of a heating screw or drum may also be combined with filling bodies loosely introduced into the flow of plastic bits (see FIG. 1).

In the embodiments according to FIGS. 2a and 2b it may also be intended that the filling bodies 200 are not rigidly connected to the heating devices, respectively, heating screw and heating drum, but that the connection is basically detachable. This means that the individual filling bodies can be connected to the heating devices, for example, by a click system or by means of screw connections. It may also be provided that the heat exchange between the heating device and the filling bodies is not only realized by the physical contact, but that a separate heat supply is provided for each filling body, or that radiation sources are arranged in the heating zone 202 which heat the filling bodies 220 selectively, e.g. by inputting specific radiations (radiation of a specific wavelength range). Moreover, in order to obtain a better heating profile for the flow of plastic bits 110 it may be provided that the filling bodies 220 are configured to be movable, meaning that they can rotate, for example. Thus, the mixing of the plastic bits is improved and, at the same time, a larger effective surface area is created.

As the filling bodies 220 are basically made of a different material than the plastic bits, it may also be provided that the entire heating zone 202 is suffused with radiation which is only poorly absorbed by the plastic bits 110, but is very well absorbed by the filling bodies 220 so that same are heated on account of the irradiation. As the filling bodies 220, again, emit the heat only by physical contact to the plastic bits 110 it is ensured that no carbonization takes place by the heat input resulting from radiation that can be absorbed by the plastic bits only at the surface area thereof. In terms of construction such a heating of the filling bodies 220 can prove to be clearly more simple than providing a corresponding heat supply, e.g. in the form of hot water supply lines, for each filling body, for example in the heating screw 201 or the heating drum 205.

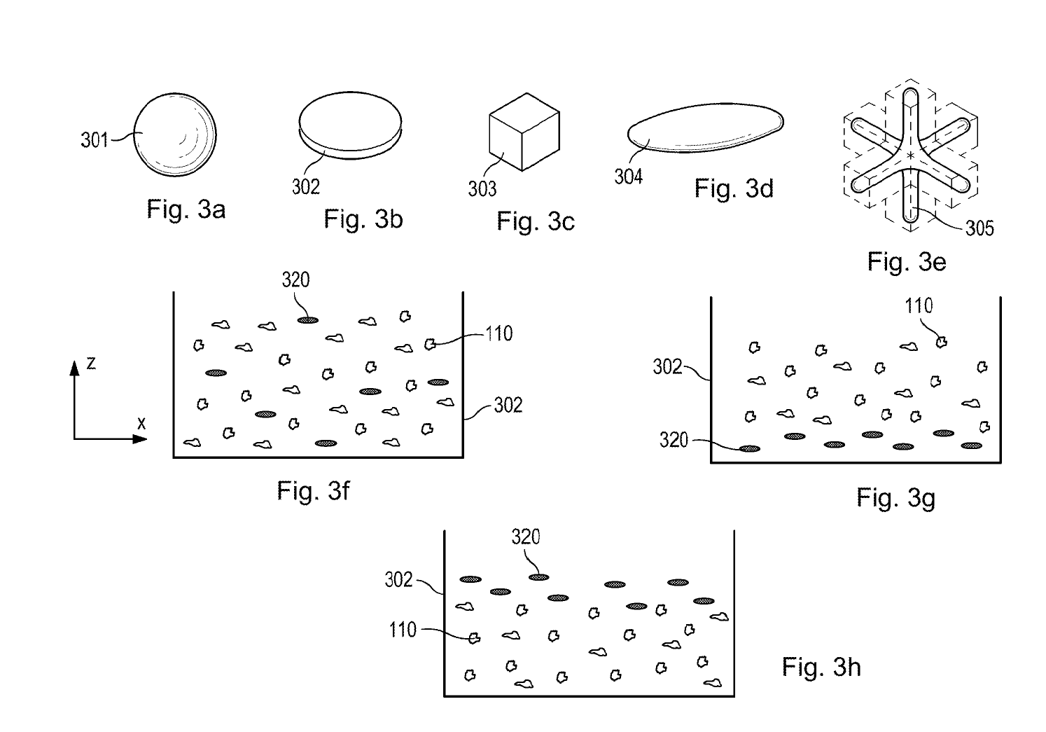

FIGS. 3a thru 3e show embodiments of the filling bodies for the embodiment illustrated in FIG. 1. Easy to manufacture are regularly shaped filling bodies that are made of plastic materials or other materials, that are easy to shred and shape. However, these filling bodies have different sizes, with the consequence that they accumulate in a flow of plastic bits, possibly due to the Brazil nut effect, in strongly different depth layers of the flow of plastic bits. Therefore, it is provided that the filling bodies have a regular shape, e.g. a ball shape 301 (FIG. 3a). The advantage of the ball is that the plastic bits are not damaged or abraded as a result of the physical contact with the filling bodies, as balls have no edges or corners where an abrasion of the partially heated plastic bits may occur. Also, the ball has the smallest ratio between surface area and volume, so that the obtained heat exchange with the plastic bits is only low, as compared to the size of the filling bodies. However, a carbonization of the plastic bits can thus be avoided. To ensure a very fast heat transfer to the plastic bits the balls have to be disproportionately large as compared to the size of the individual plastic bits. However, if the filling bodies are significantly larger than the individual plastic bits they accumulate, on account of the Brazil nut effect, above or on the plastic bits, preferably in a layer, when the total mixture is agitated or stirred during the transport through the heating zone, so that a one-sided heating of the plastic bits takes place, and the heat input is not, as originally intended, carried by the filling bodies into the depth. Advantageously, also other geometrical shapes may be used for the filling bodies. In order to prevent the changing of layers, respectively, the accumulation of the filling bodies in certain depth layers on account of the Brazil nut effect, it may be provided that the mixing is realized only at relatively low speeds so that the movement of the individual plastic bits and filling bodies is only reduced. This can be achieved by using a reactor, in particular a shaft reactor.

Thus, for example, small cylindrical plates 302 (FIG. 3b) may be used. On the one hand, they have large surfaces owing to the circle areas limiting them, via which heat can be given off to the plastic bits. On the other hand, they resemble to a great extent the plastic bits themselves with respect to their outer shape, so that, if the density and mass and size are correspondingly chosen, they can be easily distributed in the mixture of plastic bits, preferably even entirely statistically, so that a uniform heating of the plastic bits can be achieved. Analogously, cuboids 303 (FIG. 3c) or ellipsoids 304 (FIG. 3d) may be used. The cuboids have large surfaces due to their flat limiting surfaces, which allow a heat exchange to take place between the filling bodies and the plastic bits. However, due to their angular surface they have the drawback that an abrasion may take place on the plastic bits, with the consequence that individual plastic particles accumulate in the heating zone and stick to one another. This problem may be overcome by using filling bodies which have the shape of a cuboid 303, but have rounded corners and edges.

Moreover, more complicated geometrical shapes may be used, which are in particular characterized by a large surface area so that a good heat emission to the plastic bits in the surrounding plastic flow may be realized. Preferably, bodies are used that can particularly well be statistically distributed in a permanently mixed flow of plastic bits. Thus, the plastic bits may have the shape designated, for example, with 305, which is substantially a three-dimensionally formed cross with six arms (FIG. 3e). As angular surfaces are disadvantageous due to the abrasion of the plastic bits, however, the three-dimensional cross 305 is formed of rounded arms so that the entire structure does not have edges or corners. This three-dimensional cross structure has a significantly larger surface area than regular geometrical structures, such as a ball or a cuboid having the same volume. The ratio

$$\frac{A}{V}$$

of surface area to volume, which is relevant for the emission of heat, is therefore more beneficial in this case, and allows a fast heat exchange. It is, therefore, particularly suited for the heating of plastic bits. Due to the individual arms it may happen, however, that filling bodies get jammed with each other, which may lead to an accumulation of filling bodies at a certain point in the mixture of filling bodies and plastic bits, with the ultimate consequence that they sink or rise in the entire flow, which may have an adverse effect on the uniform heating.

FIG. 3f furthermore shows another property of the filling bodies, whose manipulation can influence the capability of heating the plastic bits. The larger the filling body, the more will an accumulation of filling bodies take place in a layer proximate to the surface, or above the plastic bits, during the mixing as, due to the Brazil nut effect, the smaller plastic bits occupy the created spaces during the mixing or upon shaking. On the other hand, a quantity of filling bodies may be produced by a suited material choice, which slide downwardly in the total flow of plastic bits and filling bodies as a result of their density.

In the ideal case it is provided that based on the shape, the density and the size of the filling bodies, the distribution of the filling bodies in the plastic bits flow is carried out such that the filling bodies are statistically uniformly distributed over the overall extension of the plastic bits flow. Thus, it is possible to ensure a heating of the entire plastic bits flow by the filling bodies that is as ideal as possible. This is illustrated, for example, in FIG. 3b. As shown, the plastic bits 110 and the filling bodies 320 are uniformly distributed in the heating zone both in the vertical direction (z-axis) and the horizontal direction (x-axis).

However, if it can be ensured, for example by the heating device itself, that a portion of the plastic bits is already sufficiently heated it may, in fact, be advantageous in some embodiments if an accumulation of the filling bodies takes place, e.g. due to the Brazil nut effect or higher/lower density. Thus, FIG. 3g shows filling bodies which sink downwardly in the mixture of plastic bits and filling bodies due to their higher density. Thus, it can be achieved that the plastic bits are also heated, for example, from a side facing away from the heating apparatus. Analogously, FIG. 3h illustrates the case in which the filling bodies accumulate on the plastic bits 110 either due to their size, or due to their density which is lower than that of the plastic bits. Thus, a heating of the plastic bits from the top can be realized. Corresponding filling bodies could additionally be used, for example in the embodiment according to FIG. 2b, in order to improve the heating of the upper layers. As the filling bodies will, at any rate, easily sink into the plastic bits because the plastic bits do not form a solid surface, a heating not only of the surface area is realized, but heat is also transferred into the deeper layers.

Basically, a particularly preferred shape for the filling bodies is a shape that corresponds to the average plastic bits with regard to size and outer shape. That is, the filling bodies have maximum dimensions from a few millimeters up to some centimeters in any direction (length, width, height). For example, the filling bodies may be cylindrical and have a radius of 1-2 cm and a height of 1-3 mm. If the density of the material used for the filling bodies, too, is chosen correspondingly, it may be the case that the ratio of surface area to volume does, in fact, not have the ideal value for the heat input into the plastic bits, but it is possible to thus realize a perfect mixing, or a mixing as ideal as possible, of filling bodies and plastic bits. All shapes deviating from this shape can fulfill special requirements, e.g. ensure a particularly fast heat emission to the plastic bits if the surface area is very large relative to the volume. It will be appreciated that the described shapes of filling bodies, loosely distributed in the plastic bits flow, or connected to the heating zone or the heating device, are only examples. Any other shapes, in particular irregular shapes, are also conceivable and may be used depending on the requirements.

What is claimed is:

1. An apparatus for heating plastic bits, comprising a heating zone in which introduced plastic bits can be heated, and a heating device which is suited to conduct heat into the heating zone the apparatus further comprising filling bodies which can be introduced into the heating zone and are suited to give off absorbed heat to the plastic bits in the heating zone.

2. The apparatus according to claim 1, wherein one of:
the filling bodies can be passed through the heating zone with the plastic bits; or, the filling bodies are located in the heating zone.

3. The apparatus of claim 1, the heating zone comprising a heating screw.

4. The apparatus of claim 1, the heating device comprising at least one of a microwave radiation source, an infrared radiation source, an induction heater, or a heatable inner surface area of the heating zone, which are suited to heat the filling bodies.

5. The apparatus of claim 1, the density of the filling material bodies corresponding to a medium density of the plastic bits.

6. The apparatus of claim 1, being the filling bodies fixedly connected to the surface area of the heating zone.

7. The apparatus of claim 1, further comprising a mixing device which is arranged in the heating zone and is suited to mix plastic bits in the heating zone.

8. The apparatus of claim 1, the outer shape of the filling bodies being at least one of free of edges or free of corners.

9. The apparatus of claim 1, and ratio A/V of surface area to volume of the filling bodies is greater than that of a ball having the same volume.

10. The apparatus of claim 1, in combination with a supply device suited to supply the filling bodies to the plastic bits.

11. A method for heating plastic bits, comprising filing the plastic bits into a heating zone conducting heat via a heating device into the heating zone (101), and introducing filling bodies into the heating zone, which give off absorbed heat to the plastic bits in the heating zone.

12. The method of claim 11, further comprising passing the filling bodies through the heating zone with the plastic bits.

13. The method of claim 11, further comprising mixing the plastic bits in the heating zone by a mixing device.

14. The method of claim 11, and introducing heat into the interior of the heating zone by at least one of a microwave radiation source, an infrared radiation source, an induction heater, or a heatable inner surface area of the heating zone.

15. The method of claim 11, and in introducing filling bodies, the filling bodies have an absorption maximum in at least one of the microwave range or infrared range.

16. The apparatus of claim 1, in combination with a separating device suited to separate the filling bodies from the plastic bits.

17. The method of claim 11, further comprising, prior to filing the plastic bits into the heating zone, locating the filling bodies in the heating zone.
